(19) United States
(12) Patent Application Publication
(10) Pub. No.: US 2016/0042224 A1
(43) Pub. Date: Feb. 11, 2016

(54) An Apparatus and Associated Methods

(71) Applicant: NOKIA TECHNOLOGIES OY, Espoo (FI)

(72) Inventors: Yingfei Liu, Beijing (CN); Kongqiao Wang, Beijing (CN)

(21) Appl. No.: 14/781,988

(22) PCT Filed: Apr. 3, 2013
(86) PCT No.: PCT/CN2013/073739

§ 371 Date: Oct. 2, 2015

(51) Int. Cl. G06K 9/00; G06K 9/46; G06T 7/00

(52) U.S. Cl. CPC G06K 9/00281; G06T 7/0042; G06K 9/46; G06T 2207/30201; G06K 2009/4666

(57) ABSTRACT

An apparatus, the apparatus comprising at least one processor, and at least one memory including computer program code, the at least one memory and the computer program code configured, with the at least one processor, to cause the apparatus to perform at least the following: based on a detected user position indication of a facial feature associated with a face, provide for anchoring of the position of a corresponding computer generated facial feature so that facial landmark localisation for the corresponding computer generated facial feature can be anchored around the corresponding position on a computer generated image of the face.

### TECHNICAL FIELD

The present disclosure relates to image processing using electronic devices, associated methods, computer programs and apparatus. Certain disclosed embodiments may relate to portable electronic devices, for example so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

An electronic device may allow a user to edit a computer image. For example, a user may be able to edit a computer based image by changing colours, adding or removing features from the image, or applying an artistic effect to the image. Such a device may allow a user to interact with the computer image to edit it in different ways.

The listing or discussion of a prior-published document or any background in this specification should not necessarily be taken as an acknowledgement that the document or background is part of the state of the art or is common general knowledge. One or more embodiments of the present disclosure may or may not address one or more of the background issues.

### SUMMARY

In a first example embodiment there is provided an apparatus comprising at least one processor and at least one memory including computer program code, the at least one memory and the computer program code configured to, with the at least one processor, cause the apparatus to perform at least the following: based on a detected user position indication of a facial feature associated with a face, provide for anchoring of the position of a corresponding computer generated facial feature so that facial landmark localisation for the corresponding computer generated facial feature can be anchored around the corresponding position on a computer generated image of the face.

For example, a user may view a computer generated image of her face on the display of a device. A user may be able to indicate the position of a facial feature, such as her forehead, on her own face by, for example pointing to it. Based on the detected user position indication of her forehead, the apparatus is configured to provide for anchoring of the position of the corresponding computer generated forehead feature in the computer generated image. Thus, facial landmark localisation for the forehead in the computer generated image can be anchored around the position on the computer generated image of the user's face which corresponds to the position of the forehead pointed to by the user. This may advantageously allow for more accurate facial feature detection in computer generated images via a simple and intuitive user interaction with his or her own face.

Facial landmark localisation may be considered the process of using a computer/processor/algorithm/software code to identify/detect where a particular facial feature is located in a computer generated image of a face. Such algorithms are known to the skilled person and include use of, for example, an active appearance model (AAM) or an active shape model (ASM).

Anchoring of the position of the corresponding computer generated facial feature may be considered to be fixing the position of the computer generated facial feature at a particular point in the image, so that facial landmark localisation can use the anchor position as a basis for detecting where the facial feature is located in the image. The anchor/fixing point is based on a user position indication, such as a user pointing to a feature on her face with a finger or pen, for example.

The apparatus may be configured to perform the facial landmark localisation for the corresponding facial feature anchored around the corresponding position on the computer generated image of the face. In other embodiments, a different apparatus can perform the facial landmark localisation.

The apparatus may be configured to provide for the anchoring by adjusting the position of the corresponding facial feature, as already identified using facial landmark localisation, to be anchored around the corresponding position on the computer generated image of the face. Thus, for example, the apparatus may be configured to adjust facial landmarks which have been already generated for the image (or just already identified rather than generated) based on the user's feature indication on her own face.

The apparatus may be configured to provide for the anchoring by associating the position of the corresponding facial feature for first time use by facial landmark localisation so that facial landmark localisation of the corresponding facial feature is anchored around the corresponding position on the computer generated image of the face. Thus the apparatus may be configured to initially position generated/identified facial landmarks on the image based on the user's indication of a feature on her face.

A face landmark localisation method can be implemented based on an active appearance model (AAM) or an active shape model (ASM), for example.

The facial landmark localisation for the corresponding facial feature may comprise positioning a plurality of facial landmark points on the computer generated image of a face to provide for localisation of the feature. For example, facial landmark localisation of a nose on an image may comprise the positioning of 13 facial landmark points on and around the nose region of the image. The facial landmark localisation may comprise the use of a plurality of facial landmark points for a feature in the localisation of the feature on the computer generated image of the face.

The apparatus may be configured to provide for anchoring of the position of the corresponding facial feature by adjusting the position of one or more of a plurality of facial landmark points positioned on the computer generated image of a face.

The plurality of facial landmark points may correspond to one or more of the following corresponding facial features: left eye, right eye, left eyebrow, right eyebrow, left cheek, right cheek, face outline, left ear, right ear, lips, nose, forehead, cheeks and chin.

In some examples, the positions of points associated with the corresponding facial feature only may be adjusted, such as adjusting the facial landmark points outlining a user's lips in an image based on the user position indication of her lips on her face. In other examples the positions of points associated with the corresponding facial feature and one or more other points associated with one or more other facial features may be adjusted. For example, the facial landmark points outlining a user's lips and chin outline may be adjusted in an image based on the user indicating her lips on her face.

The apparatus may be configured to detect the user position indication of a facial feature associated with a face. For example, the apparatus may comprise a front facing camera configured to detect the user position indication of a facial feature associated with a face. In other examples, the apparatus may itself not detect the user position indication but may receive appropriate signalling from an apparatus/device which performs the detection.

The detected user position indication of a facial feature associated with a face may comprise detection of the user pointing on the face to one of the following: left eye, right eye, left cheek, right cheek, left ear, right ear, lips, nose, forehead or chin.

The user position indicated may be based on user selection of a predefined facial feature before or after the user position indication. The predefined facial feature may be one of the following: left eye, right eye, left eyebrow, right eyebrow, left cheek, right cheek, left ear, right ear, lips, nose, forehead or chin.

For example, the user may be able to select a “lip” icon on screen before or after indicating her lips, so that facial landmark localisation for the facial feature is based on localisation of a corresponding “lip” facial feature of the user's face. In some examples the “lip” icon may be associated with a lipstick colour for applying a visual effect of lipstick to the lips in the computer generated image.

The facial feature associated with a face may be associated with a real-world face or with a real-world image of a face. For example, a user may point to her face, or may point to a photograph of her face.

The apparatus may be configured to apply a visual effect to the corresponding facial feature

The apparatus may be configured to apply a visual effect to a region indicated by one or more facial landmark points positioned on the face by the facial landmark localisation.

The visual effect applied may be one of: lipstick application, eye shadow application, eyeliner application, eyelash colour application, eyebrow colour application, cheek colour application, eye colour tinting, red-eye removal, skin texture smoothing, skin shine removal, and skin blemish removal.

The apparatus may be a portable electronic device, a mobile phone, a smartphone, a tablet computer, a surface computer, a laptop computer, a personal digital assistant, a graphics tablet, a pen-based computer, a digital camera, a watch, a virtual mirror, a toy, a non-portable electronic device, a desktop computer, a monitor/display, a household appliance, a refrigerator, a cooker, a cooling/heating system, or a server.

According to a further example embodiment, there is provided a computer program comprising computer program code, the computer program code being configured to perform at least the following: based on a detected user position indication of a facial feature associated with a face, provide for anchoring of the position of a corresponding computer generated facial feature so that facial landmark localisation for the corresponding computer generated facial feature can be anchored around the corresponding position on a computer generated image of the face.

According to a further example embodiment, there is provided a method, the method comprising: based on a detected user position indication of a facial feature associated with a face, providing for anchoring of the position of a corresponding computer generated facial feature so that facial landmark localisation for the corresponding computer generated facial feature can be anchored around the corresponding position on a computer generated image of the face.

According to a further example embodiment there is provided an apparatus comprising: based on a detected user position indication of a facial feature associated with a face, means for providing for anchoring of the position of a corresponding computer generated facial feature so that facial landmark localisation for the corresponding computer generated facial feature can be anchored around the corresponding position on a computer generated image of the face.

The present disclosure includes one or more corresponding aspects, embodiments or features in isolation or in various combinations whether or not specifically stated (including claimed) in that combination or in isolation. Corresponding means and corresponding function units (e.g., facial feature position indication detector, computer generated facial feature anchorer, facial landmark localiser, and corresponding position determiner) for performing one or more of the discussed functions are also within the present disclosure.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product. Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to one embodiment of the present disclosure;

FIG. 2 illustrates an example apparatus embodiment comprising a number of electronic components, including memory, a processor and a communication unit, according to another embodiment of the present disclosure;

FIG. 3 illustrates an example apparatus embodiment comprising a number of electronic components, including memory and a processor, according to another embodiment of the present disclosure;

FIGS. 4a-4b illustrate a user indication of a facial feature being detected by a portable electronic device according to embodiments of the present disclosure;

FIGS. 5a-5b illustrate a plurality of facial landmark points on a computer generated image of a user's face according to embodiments of the present disclosure;

FIGS. 6a-6d illustrate adjusting the position of a facial feature on a computer generated image of a user's face according to embodiments of the present disclosure;

FIGS. 7a-7f illustrate adjusting the position of a plurality of facial landmark points positioned on a computer generated image of a user's face and applying a visual effect according to embodiments of the present disclosure;

FIGS. 8a-8b each illustrate an apparatus in communication with a remote computing element;

FIG. 9 illustrates a flowchart according to an example method of the present disclosure; and

FIG. 10 illustrates schematically a computer readable medium providing a program.

### DESCRIPTION OF EXAMPLE ASPECTS/EMBODIMENTS

An electronic device may allow a user to edit a computer image. Such a device may allow a user to interact with the computer image to edit it in different ways. For example, a user may wish to edit a computer image of his/her face to improve his/her appearance. The user may wish to, for example, apply an effect to the image of lipstick applied to the lips, of smoother or less shiny skin on the forehead, or of blusher/colour applied to the cheeks.

It may be desirable for a user to be able to change the appearance of a photograph of his/her face accurately. An edited image of a user's face may look unnatural or less attractive if, for example, a lipstick effect is applied to a region of the user's face which is not on the lips, or if a smoothing effect was applied over a region including the user's forehead and hair instead of over the forehead only.

It may be desirable for a user to be able to edit an image of his/her face using an intuitive and simple user interface. For example, using a photo editing application may be complex and unintuitive, and the desired effect may be difficult to achieve unless the user is familiar with the application. If a user wishes to edit a photograph “on the go”, for example from a smartphone or tablet computer, a user may not wish to, or be able to, use a (standard) photo editing package to edit the photograph.

It may be desirable for a user to be able to edit an image using gestures and actions which feel natural to the user. For example, a user may wish to edit an image of her face by smoothing out wrinkles. A user may find it more natural to touch/interact with her face than interact with a computer generated image of her face displayed on a monitor/display screen.

Embodiments discussed herein may be considered to allow a user to accurately and easily/intuitively edit a photograph of his/her face. For example, a user may display a photograph of him/herself on a display of an electronic device. The user is able to, for example, point to his/her cheek region and the corresponding cheek region in the image would be edited with a smoothing function to remove blemishes (such as acne, broken veins or wrinkles) in the image in the corresponding region. The user may be able to apply several different “beautification” effects to the image of his/her face. Such processes can also be applied to video images or still/video images captured in real time.

Advantageously a user may be able to indicate a position of a facial feature on his/her face. The apparatus can provide for anchoring of the position of a corresponding computer generated facial feature, so that facial landmark localisation for the corresponding computer generated facial feature can be anchored around the corresponding position on a computer generated image. Therefore, the computer generated image may contain facial landmark information designating particular regions to be associated with different facial features, such as eyes, lips, cheeks and nose, for example. By the user indicating the position of a particular feature on his/her face, the position of a corresponding feature in the image is anchored to a corresponding position in the image. The accuracy of facial feature recognition may thereby be improved, which in turn may allow for greater accuracy in photo/image editing and provide for face beautification effects applied to the photograph/image to be more accurate and realistic based on a simple and intuitive user indication such as pointing to the face (which may or may not include touching the feature on the face).

Other embodiments depicted in the figures have been provided with reference numerals that correspond to similar features of earlier described embodiments. For example, feature number 100 can also correspond to numbers 200, 300 etc. These numbered features may appear in the figures but may not have been directly referred to within the description of these particular embodiments. These have still been provided in the figures to aid understanding of the further embodiments, particularly in relation to the features of similar earlier described embodiments.

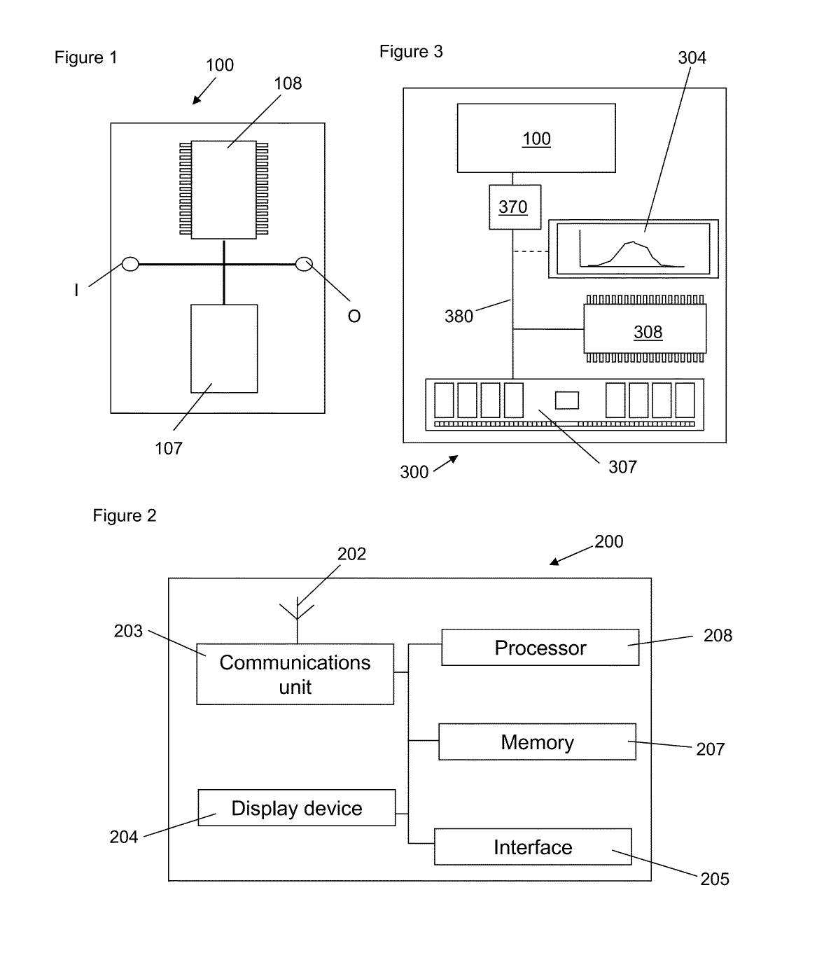

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device. The display, in other embodiments, may not be touch sensitive.

The input I allows for receipt of signalling to the apparatus 100 from further components, such as components of a portable electronic device (like a touch-sensitive or hover-sensitive display) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208.

The example embodiment of FIG. 2 comprises a display device 204 such as, for example, a liquid crystal display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300 comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

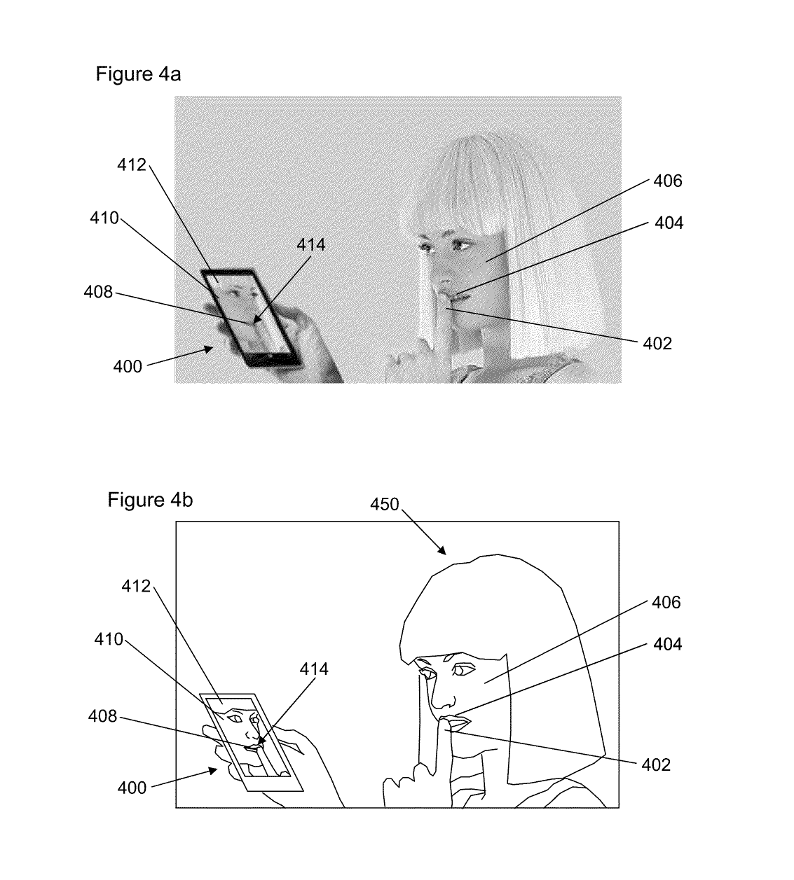

FIGS. 4a-4c illustrate example embodiments of an apparatus/device 400 comprising a display screen. The user 450 is holding the apparatus/device 400 and is viewing a computer generated image 410 of her face on the display screen. In this case, the image is a real time image.

The user 450 is indicating the position of her lips 404 by pointing to them on her face 406 with her finger 402. This user position indication 402 of a facial feature 404 associated with a face 406 is detected. In this example the apparatus/device 400 is configured to detect the user position indication 402 of the facial feature 404 associated with a face 406 (although in other embodiments, this may be done remotely from the apparatus/device 400). Based on the detection, the apparatus/device 450 is configured to provide for anchoring of the position 414 of a corresponding computer generated facial feature 408. The user's indication 402 of the position of her lips 404 is detected and the apparatus uses this detection to anchor the position 414 of the computer generated lips facial feature 408 in the computer generated image 412 on the apparatus/device 400.

Anchoring of the lip position 414 in the computer generated image 412 is performed so that facial landmark localisation for the corresponding facial feature (lips) 408 can be anchored around the corresponding position 414 on the computer generated image 412 of the face 410. The position 414 of the corresponding facial feature 408 is the position determined by facial landmark localisation (and any adjustments of the facial landmark) based on the user position indication 402.

The apparatus/device 400 is therefore provided with a user input 402 of a user's facial feature 404 which has a corresponding position 414 in the computer generated image 412. Facial landmark localisation for the facial feature 408 can be anchored about a position 414 in the computer generated image 412 corresponding to the indicated position 402 on the user's face 406.

In this example, the apparatus/device 400 is configured to perform the facial landmark localisation for the corresponding facial feature 408 anchored around the corresponding position 414 on the computer generated image 412 of the face 410. In other examples, facial landmark localisation may be performed by another apparatus/device and provide the facial landmark positions to the apparatus/device 400.

The apparatus/device 400 may allow for more accurate facial landmark localisation by the user 450 being able to providing an indication 402 of a feature position 404 to the apparatus/device 400 as a check to the facial landmark localisation application/software that a facial feature position is in the position indicated 402 by the user 450.

The apparatus/device 400 in this example is configured to perform facial landmark localisation prior to any user indication 402 of a facial feature 404 allowing for adjustment of the position of the facial feature in the image 412. Thus the apparatus/device 400 is configured to provide for the anchoring by adjusting the position of the corresponding facial feature 408, as already identified using facial landmark localisation, to be anchored around the corresponding position 414 on the computer generated image 412 of the face 410.

In other examples, the apparatus/device may be configured to provide for the anchoring by associating the position of the corresponding facial feature 408 for first time use by facial landmark localisation, so that facial landmark localisation of the corresponding facial feature 408 is anchored around the corresponding position 414 on the computer generated image 412 of the face 410. That is, facial landmark localisation may not take place until a user position indication 402 of a facial feature 404 is detected.

In the above example the user indicated her lips. In other examples the detected user position indication of a facial feature associated with a face may comprise detection of the user pointing on the face to one of the following: left eye, right eye, left cheek, right cheek, left ear, right ear, nose, forehead or chin, for example.

The user's indication 402 of a facial feature 404 can be used by the apparatus/device 400 in providing for anchoring of a corresponding computer generated facial feature as discussed above. The user's indication 402 may also be used by the apparatus/device for interacting with the computer generated facial image and editing the image. For example, a user may be able to apply visual effects to the image, such as applying make-up effects, applying skin effects such as smoothing, applying a matt/shiny effect, or changing skin tone/hue, and/or applying other effects such as lighting or colour balance. Thus the apparatus may be configured to apply a visual effect to the corresponding facial feature. The apparatus may be configured to apply a visual effect to a region indicated by one or more facial landmark points positioned on the face by the facial landmark localisation.

For example, a user may wish to apply a blusher effect to her cheeks in an image of her face displayed on a device. The user is able to touch her cheek, and the corresponding position in the computer generated image is indicated to the apparatus/device. Facial landmark localisation points corresponding to the user's cheek are positioned, or the position adjusted, based on the user indication so that when the blusher effect is applied in the image, it is in the position corresponding to that which the user has indicated on her face. Thus the apparatus may allow for an intuitive way for a user to accurately apply visual effects, such as virtual make up, to an image of his/her face.

Further, in the example of FIGS. 4a-4b the user is pointing to her real-world face. In other examples the user may be able to point to a photograph of her face, for example by pointing to a printed photographic image held in front of a camera so that user indications made on the photograph can be detected and provided to the apparatus for facial feature position anchoring.

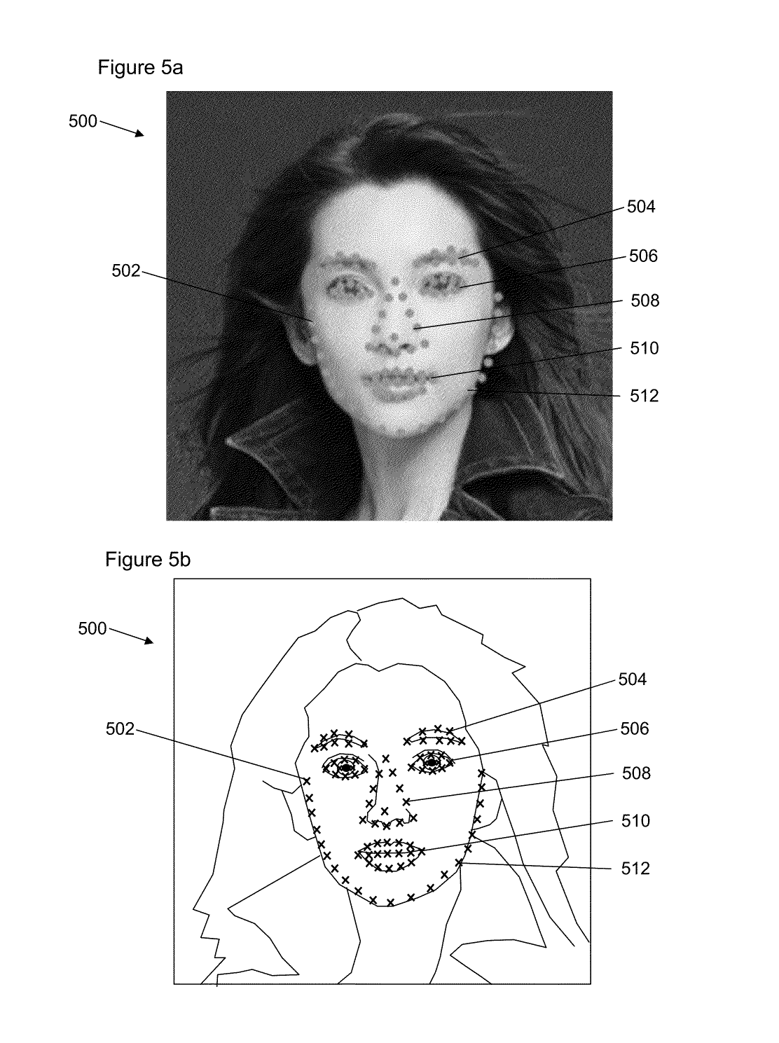

FIGS. 5a-5b illustrate an example embodiment of facial landmark recognition of a computer generated image of a user's face 500. Apparatus/devices as discussed herein provide for anchoring of the position of a corresponding computer generated facial feature based on a detected user position indication of a facial feature associated with a face, so that facial landmark localisation for the corresponding facial feature can be anchored around the corresponding position on a computer generated image of the face 500. The apparatus/device may be configured to perform facial landmark localisation, or may be configured to adjust one or more facial landmark points determined in a facial landmark localisation process.

Facial landmark localisation in this example comprises positioning a plurality of facial landmark points 502 on the computer generated image of a face 500 to provide for localisation of a feature. In FIGS. 5a and 5b, the face landmark model created using facial landmark localisation has 88 feature points: 16 points for the two eyebrows 504, 16 points for two eyes 506, 13 points for the nose 508, 22 points for the mouth 510, and 21 points for the face outline 512. Other numbers of facial landmark points may be used.

Apparatus/devices as discussed herein may be configured to provide for anchoring of the position of a facial feature corresponding to a user indicated facial feature, by adjusting the position of one or more of a plurality of facial landmark points 502 positioned on the computer generated image of a face 500. For example, a user may touch her right eyebrow. The apparatus may, for example, detect the user indication, check that the positions of the facial landmark points 502 corresponding to the right eyebrow 504 are in a position corresponding to the position indicated by the user on her face, and if not, adjust the position of one or more of the facial landmark points 502 for the right eyebrow to correspond to the user indicated position.

The plurality of facial landmark points in FIGS. 5a and 5b correspond to the user's left eye, right eye, left eyebrow, right eyebrow, face outline, lips and nose. In other examples, facial landmark points may correspond to a user's left cheek, right cheek, left ear, right ear, forehead, cheeks and/or chin, for example.

The apparatus/device may be configured to perform facial landmark localisation using an active shape model, for example. In one example, the apparatus is configured to determine the positions of the plurality of facial landmark points 502 on the image of the user's face 500 by firstly using a face detection algorithm to detect a face in the image. Then, an eye detection algorithm is used to locate two eyes 506 in the image 500. The located positions of the two eyes 506 in the image 500 are then used as a benchmark to determine the location of one or more other facial features 504, 508, 510, 512 in the image using a multi-point (e.g., 88 point) facial landmark model based on an ASM convergence scheme.

Usually, the eye locations 506 determined using facial/eye recognition algorithms are taken as being accurate, which is why they may be used as a benchmark for locating other facial features 504, 508, 510, 512. Because the eye locations 506 are taken as being accurate, localisation of other features 504, 508, 510, 512 such as the nose 508 and mouth 510, for example, may be done incorrectly during the convergence. If eye locations 506 are not correctly localised, then all features on the face 500 may not be localised correctly, or in some examples may not be localised at all.

Apparatus discussed herein may provide an improved method of facial feature localisation by providing for anchoring of the position of a corresponding computer generated facial feature 504, 506, 508, 510, 512 so that facial landmark localisation for the corresponding computer generated facial feature 504, 506, 508, 510, 512 can be anchored around the corresponding position on a computer generated image 500 of the face based on a detected user position indication of a facial feature associated with a face.

For example, if the user points to an eye on her face, but there is no corresponding eye localised on the computer generated facial image 500, the apparatus may detect that the user is indicating an eye position on her face, and create/adjust a corresponding eye landmark 506 located at a corresponding position on the computer generated facial image 500. Other facial features 504, 508, 510, 512 may then by localised using a convergence scheme based on the user indicated/corrected eye location.

For other facial features, for example a mouth 510, if the facial landmark localisation localises the mouth 510 on the chin by mistake, when the user points to her mouth on her face with her finger, the mouth feature landmark 510 on the computer generated image 500 will be adjusted so that the location of the mouth landmark 510 moves to a position corresponding to the position pointed to by the user on her face. The mouth feature landmark 510 may then be converged again so that each facial landmark point associated with the mouth 510 is adjusted to mark/trace the contour of the mouth 510 in the computer image 500 (that is, during convergence the facial landmark points are positioned/adjusted to be located at the positions with largest local gradients).

The facial landmark points may be connected to each other based on the trained facial model used, accounting for the facial shape and the feature edges, for example. Thus it may be sufficient for a user to merely point to her mouth at one point and the facial landmark points associated with the mouth may be positioned/adjusted based on the facial recognition model to follow the contours of the user's mouth in the image. The user may not be required to, for example, move her finger over her mouth to indicate a corresponding mouth area. If a visual effect is to be applied to the image, it may be advantageous for the user to be able to, for example, simply point to an eye and an eyeliner effect may be applied to the upper and/or lower lash lines in the image. The user need not necessarily trace a steady path along her lash line with her finger, as the apparatus may be configured to apply the eyeliner effect to regions defined by the lash lines identified by the facial/lash line landmark localisation process.

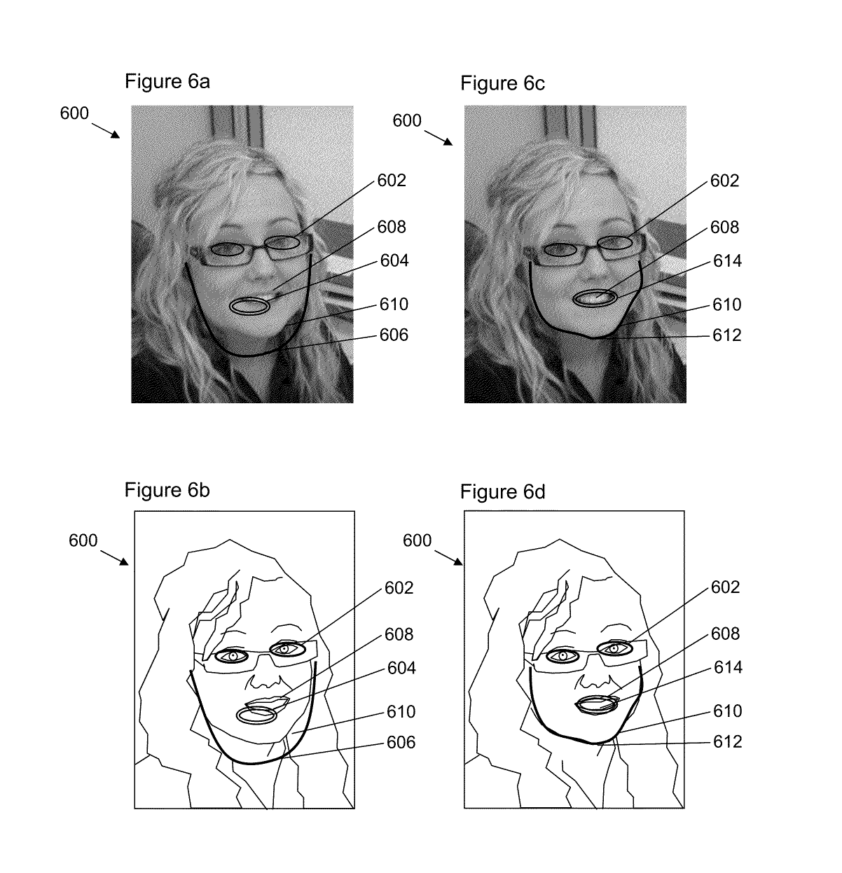

FIGS. 6a-6d illustrate an example embodiment of facial landmark recognition of a computer generated image of a user's face 600. Apparatus/devices as discussed herein provide for anchoring of the position of a corresponding computer generated facial feature as described in relation to FIGS. 5a-5b.

FIGS. 6a-6b show a computer generated image of a user's face 600, with the facial landmark locations of the user's eyes 602, mouth 604, and facial outline 606 indicated. The facial landmark localisation of the user's mouth 608 and facial outline 610 is incorrect. The mouth landmark 604 is too low and to the left of the position of the user's mouth 608 in the image. The facial outline landmark 610 is too low and large compared with the user's facial outline 606 in the image.

After the facial landmark localisation shown in FIGS. 6a-6b, the user points to her lips on her face, and this indication of the user's lip position is detected. Apparatus/devices as discussed herein are configured to use this detection of the user's lip position to anchor the position of the lips facial landmark 614 to the user indicated position. The user's indication of her lip position is detected and this indication provides feedback to the apparatus to auto-correct the position of the lip feature landmark in the image to a position corresponding to that indicated by the user. Thus in FIGS. 6c-6d, the adjusted position of the lips facial landmark 614 is shown accurately located over the user's lips 608 in the computer generated photograph 600.

When the user indicates the lips on her face, the lip feature points/region 604, 614 defined by the facial landmark localisation will be adjusted to anchor around the corresponding indicated point in the lip region 608. The lip feature points/region 604 in this example is automatically adjusted to a re-positioned lip feature points/region 614 in the position of the lips in the image based on the indication position on the user's lips on her face. The facial feature landmark points/lines 606 for the user's chin 610 in this example are simultaneously adjusted to more accurately follow the line of the user's chin 610 on the computer generated image. The adjustment of the chin facial feature landmark points/lines 606, 612 in this example is executed in association with the adjustment of lip facial feature points/region 604, 614 under the restriction of the trained ASM or AAM based face landmark model.

Since the lip facial landmark 614 has moved, the positions of facial landmarks which may also be likely to require adjustment following the re-positioning of the lips facial landmark 614 have been checked. The re-checking of the facial landmarks may be performed by a facial landmark algorithm/engine, for example, which may be comprised with the apparatus or may be separate to and communicable with the apparatus. Accordingly, the facial shape landmark 612 has also been adjusted to more closely follow the shape of the user's face 610.

Thus, the user's indication of her lip position was detected and the apparatus has used the detection to anchor the position of the lips facial feature 614 in the computer image 600 to the user indicated lip position 608. In this example, the facial shape feature landmark 612 was also adjusted. In other examples, no other facial features may be adjusted other than that associated with the user indicated facial feature position. In other examples, other facial features may be adjusted as well as the feature associated with the user indicated facial feature position, such as feature locations associated with a user's chin, cheeks, and ears, for example.

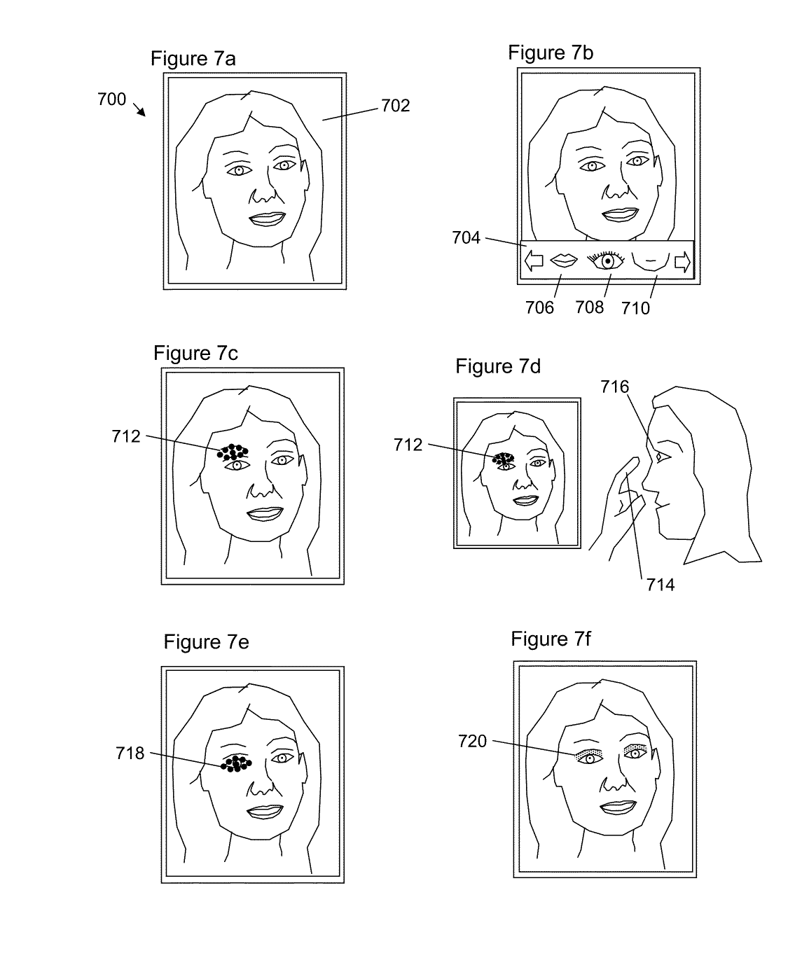

FIG. 7a-7f illustrate an example of an apparatus/device 700 displaying a photograph 702 of a user's face. The user wishes to apply a visual effect to the photograph to give the appearance of wearing eyeshadow. Based on the user indicating a facial feature on his/her face, the apparatus provides for anchoring of a corresponding computer generated facial feature in a computer image to correspond to the user indicated position. The user's position indication may also be detected as a visual effect application input, to apply a beautification effect to the image in the anchored region corresponding to the user's indicated facial feature.

In FIG. 7a, the user's photograph 702 is displayed on the apparatus/device 700. In FIG. 7b, the user is presented with a virtual make up palette 704 where a user may select a make up option. The example options displayed are for lipstick application 706, eye make up application 708 and skin smoothing 710. In this example the user selects the “eye” option 708. In this example, the user's selection of an eye not only allows for a particular eye make up effect to be selected, but also indicates to the apparatus 700 that the next user indication made on the user's face will be to point to an eye. This user indication therefore acts as a prompt to the apparatus that location information about the position of the user's eye is about to be provided, so that the position of the facial landmark corresponding to the user's eye in the image 702 may be anchored around a position corresponding to the user-indicated eye position. Use of such a selection menu/palette, prior or subsequent to user position indication of a facial feature, can also be used in the previously described embodiments of FIGS. 4a-4b, 5a-5b and 6a-6d (with or without the application of a visual effect as per the present example embodiment).

It will be appreciated that the virtual make up palette may allow for different options for particular facial features. For example, if a user selects the “eye” option 708, the user may then be able to select from, for example, applying eyeshadow, eyeliner, mascara, iris colour, eye white whitening, red-eye removal, and under-eye lightening, for example. The user may be able to select a colour for certain options (such as eyeshadow and mascara application, for example).

In FIG. 7c, facial landmark localisation has been performed and the determined position of the user's right eye 712 is indicated on the device 700. It will be appreciated that this view may not necessarily be displayed to the user on the device 700. Further, other facial features such as the user's left eye, nose, mouth and face outline may also be determined using the facial feature localisation. These are not shown in the figures for clarity. Further, the eye facial landmark is shown in FIGS. 7c-7e as a series of nine facial landmark points, but in other examples the landmark may be a continuous outline, or a series of more or fewer facial landmark points for example.

The facial landmark localisation has incorrectly positioned the eye landmark 712 too high on the user's photograph, so that it lies between the user's eyebrow and eye, rather than over the eye. At this point, the user may not (and need not) be aware of where the facial landmark localisation has determined the user's eye to be positioned on the photograph.

In FIG. 7d, the user provides a user indication 714 on her face of her eye 716 to which she wishes the photograph to be correspondingly enhanced with an eyeshadow effect. This user indication 714 is detected, and based on this detection, the apparatus/device 700 provides for anchoring of the position of the corresponding facial feature in the computer generated image 702, so that facial landmark localisation for the corresponding eye facial feature can be anchored around the corresponding position on the computer image of the user's face 702. Of course the eye landmark 712 may not be displayed to the user.

FIG. 7e shows that facial landmark localisation of the user's eye has been re-performed, and the adjusted determined position of the user's right eye 718 is indicated on the device 700. Again, as in relation to FIG. 7c, this view may not necessarily be displayed to the user on the device 700.

In other examples, the facial landmark localisation may not be performed until the user has made a user indication of a facial feature on her face. In such an example the stage shown in FIG. 7c would not be performed, and rather than a facial landmark feature being re-localised, the landmark would be initially localised based on the user's indication 714 on her face 716 of a particular feature.

FIG. 7f shows that the user's selected visual effect has been applied to the image 702 and the photograph 702 has been edited to give the appearance of the user wearing the selected eyeshadow 720. The accuracy of the applied visual effect may be greater than if no re-adjustment of facial feature localisation had taken place based on the user indicating 714 her eye position on her face 716. Further, the user may be provided with a “virtual mirror” user experience. The user may use the apparatus/device 700 as a virtual mirror for the application of virtual make-up and facial enhancement effects, and the user may use realistic make-up application gestures to enhance a computer generated image.

Other examples may include be that a user can select an “acne removal” tool from the virtual palette 704, and select removal from the forehead region. When the user touches/indicates her forehead, this user indication is provided to the apparatus so that the visual effect of acne removal is applied in a position corresponding to the place where the user is pointing to on her forehead. The apparatus anchors the forehead region around the user-indicated position and removes acne from the corresponding area on the photograph. The user indication may provide for a more accurate determination of the outline of the user's upper face, so that acne removal effects are applied to the user's skin, but not over the user's hairline, for example.

In relation to detecting the user's indication on his/her face, the user may use, for example, a finger to point to a facial feature. In other examples, the user may use a wand or stylus to point to a facial feature. The position of the finger/wand may be performed using a hand tracking/wand tracking algorithm. The algorithm may be able to determine the position of the end/tip of the finger/stylus and determine the corresponding location on a user's face which the fingertip/wand end is pointing to. The finger/stylus may or may not touch the user's face. In certain examples, a user may use more than one finger to indicate a facial feature. For example, if a user wishes to provide a skin smoothing effect over a cheek, the user may use three fingers held together to rub his/her cheek. The positions of the user's fingertips in the cheek area of the user's face may be tracked and a corresponding cheek facial landmark in the computer generated image may be anchored about a point related to the tracked path of the user's fingers. For example, the cheek facial landmark may be anchored about a point located within the detected path of the user's fingers.

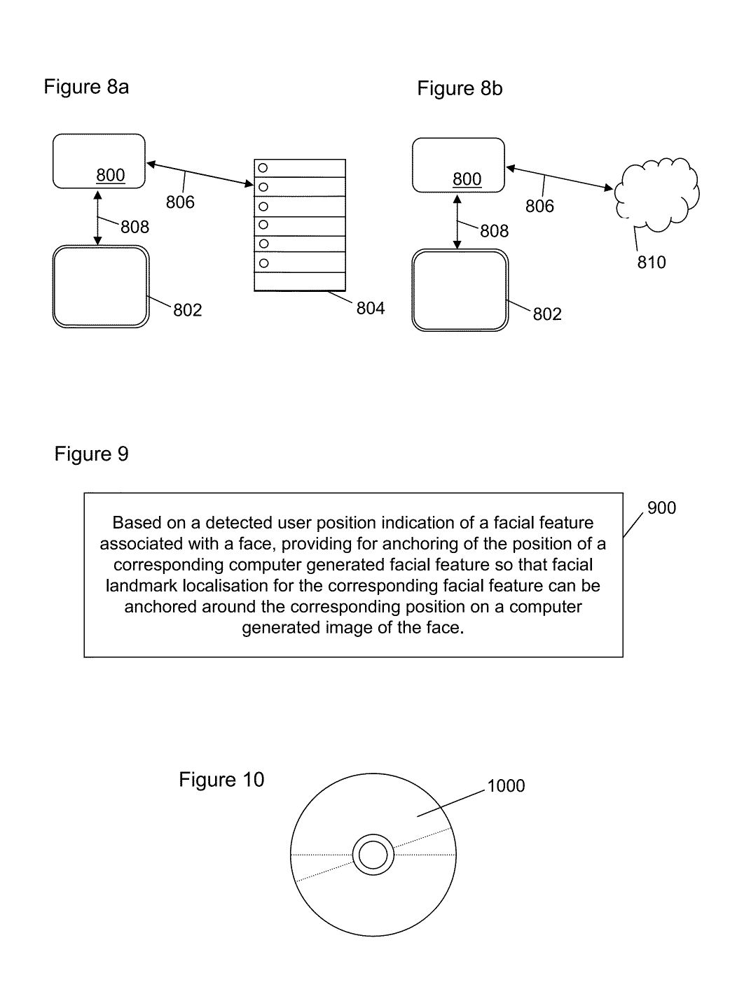

FIG. 8a shows an example of an apparatus 800 in communication with a remote server. FIG. 8b shows an example of an apparatus 800 in communication with a “cloud” for cloud computing. In FIGS. 8a and 8b, apparatus 800 (which may be apparatus 100, 200 or 300) is also in communication with a further apparatus 802. The apparatus 802 may be a touch screen display or camera for example. In other examples, the apparatus 800 and further apparatus 802 may both be comprised within a device such as a portable communications device or PDA. Communication may be via a communications unit, for example.

The computer generated image of the user may be a pre-captured image of the user, for example a photograph taken before the user provided a user indication of a facial feature. The computer generated image of the user may be a photograph captured in a self-portrait using, for example, a front facing camera of an apparatus/device. The computer generated image may in certain examples be a live video capture.

FIG. 8a shows the remote computing element to be a remote server 804, with which the apparatus 800 may be in wired or wireless communication (e.g. via the internet, Bluetooth, NFC, a USB connection, or any other suitable connection as known to one skilled in the art). In FIG. 8b, the apparatus 800 is in communication with a remote cloud 810 (which may, for example, be the Internet, or a system of remote computers configured for cloud computing). For example, the apparatus providing/capturing the computer generated image of a face and/or edited version of the image may be a remote server 804 or cloud 810. A facial landmark localisation algorithm may run remotely on a server 804 or cloud 810 and the results of the localisation may be provided to the apparatus (the server/cloud being fed the results of the user position indication and/or signalling representing the anchoring e.g., identification of features and the position of the features). In other examples the second apparatus may also be in direct communication with the remote server 804 or cloud 810.

FIG. 9a illustrates a method 900 according to an example embodiment of the present disclosure. The method comprises, based on a detected user position indication of a facial feature associated with a face, providing for anchoring of the position of a corresponding computer generated facial feature so that facial landmark localisation for the corresponding computer generated facial feature can be anchored around the corresponding position on a computer generated image of the face.

FIG. 10 illustrates schematically a computer/processor readable medium 1000 providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
based on a detected user position indication of a facial feature associated with a face, provide for anchoring of the position of a corresponding computer generated facial feature so that facial landmark localisation for the corresponding computer generated facial feature can be anchored around the corresponding position on a computer generated image of the face.

2. The apparatus of claim 1, wherein the apparatus is configured to perform the facial landmark localisation for the corresponding facial feature anchored around the corresponding position on the computer generated image of the face.

3. The apparatus of claim 1, wherein the apparatus is configured to provide for the anchoring by adjusting the position of the corresponding facial feature, as already identified using facial landmark localisation, to be anchored around the corresponding position on the computer generated image of the face.

4. The apparatus of claim 1, wherein the apparatus is configured to provide for the anchoring by associating the position of the corresponding facial feature for first time use by facial landmark localisation so that facial landmark localisation of the corresponding facial feature is anchored around the corresponding position on the computer generated image of the face.

5. The apparatus of claim 1, wherein the facial landmark localisation for the corresponding facial feature comprises positioning a plurality of facial landmark points on the computer generated image of a face to provide for localisation of the feature.

6. The apparatus of claim 1, wherein the apparatus is configured to provide for anchoring of the position of the corresponding facial feature by adjusting the position of one or more of a plurality of facial landmark points positioned on the computer generated image of a face.

7. The apparatus of claim 6, wherein the plurality of facial landmark points correspond to one or more of the following corresponding facial features: left eye, right eye, left eyebrow, right eyebrow, left cheek, right cheek, face outline, left ear, right ear, lips, nose, forehead, cheeks and chin.

8. The apparatus of claim 1, wherein the apparatus is configured to detect the user position indication of a facial feature associated with a face.

9. The apparatus of claim 1, wherein the detected user position indication of a facial feature associated with a face comprises detection of the user pointing on the face to one of the following: left eye, right eye, left cheek, right cheek, left ear, right ear, lips, nose, forehead or chin.

10. The apparatus of claim 1, wherein the user position indicated is based on user selection of a predefined facial feature before or after the user position indication.

11. The apparatus of claim 10, wherein the predefined facial feature is one of the following: left eye, right eye, left eyebrow, right eyebrow, left cheek, right cheek, left ear, right ear, lips, nose, forehead or chin.

12. The apparatus of claim 1, wherein the facial feature associated with a face is associated with a real-world face or with a real-world image of a face.

13. The apparatus of claim 1, wherein the apparatus is configured to apply a visual effect to the corresponding facial feature.

14. The apparatus of claim 1, wherein the apparatus is configured to apply a visual effect to a region indicated by one or more facial landmark points positioned on the face by the facial landmark localisation.

15. The apparatus of claim 1, wherein the visual effect applied is one of: lipstick application, eye shadow application, eyeliner application, eyelash colour application, eyebrow colour application, cheek colour application, eye colour tinting, red-eye removal, skin texture smoothing, skin shine removal, and skin blemish removal.

16. A computer readable medium comprising computer program code stored thereon, the computer readable medium and computer program code being configured to, when run on at least one processor perform at least the following:
based on a detected user position indication of a facial feature associated with a face, provide for anchoring of the position of a corresponding computer generated facial feature so that facial landmark localisation for the corresponding computer generated facial feature can be anchored around the corresponding position on a computer generated image of the face.

17. A method comprising:
based on a detected user position indication of a facial feature associated with a face, providing for anchoring of the position of a corresponding computer generated facial feature so that facial landmark localisation for the corresponding computer generated facial feature can be anchored around the corresponding position on a computer generated image of the face.
